(19) United States
(12) Patent Application Publication
(10) Pub. No.: US 2025/0362237 A1
(43) Pub. Date: Nov. 27, 2025

(54) APPARATUS FOR DETECTING DEFECTS IN ANODES OR CATHODES FOR BATTERIES, AND PLANT COMPRISING SUCH APPARATUS

(71) Applicant: DeCoSystem S.r.l., CALENZANO (IT)

(72) Inventor: Tiziano LASTRUCCI, FIRENZE (IT)

(21) Appl. No.: 19/185,881

(22) Filed: Apr. 22, 2025

(30) Foreign Application Priority Data
May 23, 2024 (IT) 102024000011752

(51) Int. Cl. G01N 21/88; G01N 21/95

(52) U.S. Cl. CPC G01N 21/8806; G01N 21/95

(57) ABSTRACT

Apparatus for detecting defects in an anode or cathode for batteries. The anode or cathode includes a film of electrically conducting material coated on both of its opposite faces. The apparatus includes a controller and a device arranged along a transit path of the anode or cathode. The device includes a contact image sensor, a light beam splitter, a first illuminator and a second illuminator. The first illuminator directs first light beams onto the light beam splitter, which deflects the first light beams towards a first face of the anode or cathode. The second illuminator sends second beams of grazing light toward the first face. The controller drives the illuminators to emit the respective light beams in a synchronized and alternating manner. The contact image sensor captures images of the first face when illuminated and the controller detects the presence of defects based on the captured images.

The present disclosure relates to an apparatus for detecting defects during the production of anodes and cathodes for batteries, and to a plant for the production of batteries, and/or of anodes and/or cathodes for batteries, comprising at least such apparatus.

As it is well known, in the last years the use of batteries has experienced a significant upsurge in several technical fields; e.g., in the automotive field, in which the development of electrically powered vehicles is constantly evolving and growing.

The production process of such batteries as a whole, as well as of the various components, especially of the electrodes, is particularly complex.

For example, the production of anodes and cathodes includes the use of a film of electrically conducing material, e.g., copper or aluminum, which is coated, on at least part of both of its principal faces, by an appropriate coating layer, made for example by graphite or by another similar material or in any case suitable for the purpose.

Clearly, this process, in its various steps, plays an important role to guarantee the effectiveness of the performances of the batteries and the competitiveness and success of the companies involved in their production, commercialization and application chains.

Indeed, any defects in the production of electrodes may not only cause undesired waste or production inefficiencies, but they can then lead to malfunctions in the apparatuses that use them, e.g., electrical vehicles, if not properly identified during the production stage.

Therefore, there is room and desire for improving the way of finding any defects in the production of anodes and cathodes for batteries.

In one aspect, the present disclosure provides an apparatus for controlling and detecting defects in an anode or cathode for batteries, said anode or cathode comprising a film of electrically conducting material coated at least in part, and on both of its opposite faces, by a coating layer, wherein the apparatus comprises:
at least one controller;
at least a first device which is arranged along a path along which said anode or cathode to be controlled is passed and which comprises, arranged at a first face of the film:
a first contact image sensor;
a first light beam splitter;
a first illuminator which is configured to send on said first light beam splitter first light beams, said first light beam splitter being configured to deflect at least part of said first light beams towards said first face of the anode or cathode;
a second illuminator configured to send second beams of substantially grazing light toward said first face of the anode or cathode;
   wherein said at least one controller is configured to drive said first and second illuminators so that they emit said first and second light beams in a synchronized and alternating manner with each other;
   wherein said at least one controller is configured to drive said first and second illuminators so that they emit said first and second light beams in a synchronized and alternating manner with each other;
   wherein said first contact image sensor is configured to capture first and second images of at least part of said first face of the anode or cathode when illuminated by said at least part of said first light beams deflected and said second light beams, respectively;
   and wherein said at least one controller is configured to detect the presence of one or more defects that may be present on at least said first face of said anode or cathode at least based on said first and second images captured by said first contact image sensor.

In another aspect, the present disclosure provides a plant for producing batteries, and/or anodes and/or cathodes for batteries, comprising at least such apparatus.

Particular embodiments form the subject of dependent claims, whose content is intended as an integral part of the present description.

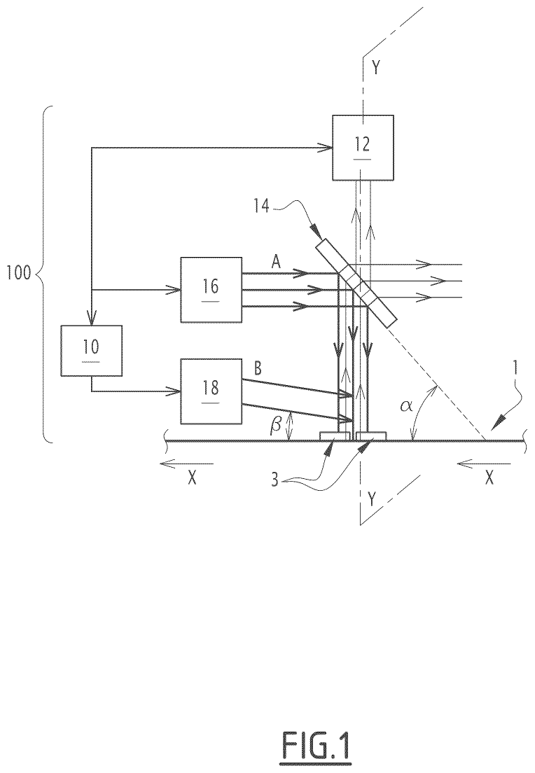

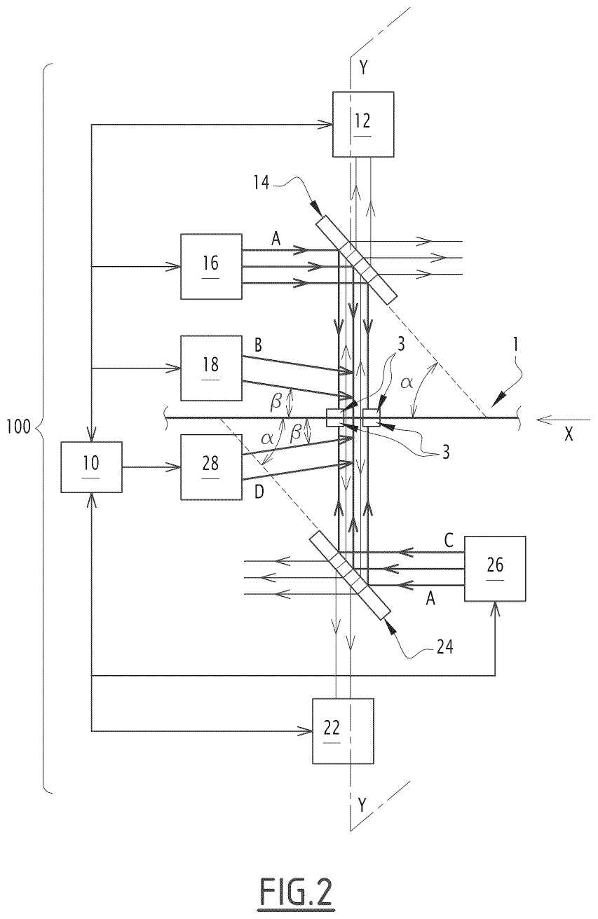

Further features and advantages of the disclosure will become apparent from the following detailed description, given by way of non-limiting example, with reference to the attached FIGS. 1 and 2 which schematically show, according to a side view, possible embodiments of an apparatus for controlling and detecting defects in an anode or cathode for batteries.

It should be noted that, identical or similar components, from a structural and/or functional point of view, could have same or different reference numbers in the following detailed description, regardless of whether they are illustrated in different embodiments or separate parts of the present disclosure.

It should also be noted that, in order to clearly and synthetically describe the present disclosure, the components illustrated may not be to scale and some features of the description may be illustrated in a somehow schematic form.

Moreover, when the term “adapted”, or “configured”, or “shaped”, or a similar term is used in the present document, referring to any component as a whole, or to any part of a component or to a combination of components, it has to be intended that it means and correspondingly comprises the structure and/or the configuration and/or the shape and/or the positioning.

In particular, whenever such terms refer to hardware or software electronic means, they should be intended as including circuits or parts of electronic circuits, as well as software/firmware, such as algorithms, routines and programs in general, running and/or residing in any storage support.

In addition, when the term “about”, or “substantial”, or “substantially” is used herein, it should be intended as comprising a variation due to unavoidable manufacturing tolerances, or a current variation of more or less than 5% with respect to what is indicated as the reference value, direction or position.

Finally, in the following description and claims, the ordinal numbers first, second, etc., will be used for the sake of illustrative clarity and should not be intended as limiting for any reason, nor that the order should be exactly the one in the sequence described, with reference to the example embodiments described. For example, the indication of a first light beam, a second light beam, a third light beam, a fourth light beam does not imply that said beams are emitted in such a sequence, or that the light beams mentioned are necessarily present in every possible embodiment.

FIGS. 1 and 2 schematically show possible embodiments of an apparatus for controlling and detecting any defect in an anode or cathode for batteries, generally indicated with the reference number 100.

According to embodiments well known and for this reason not described herein in details, an anode or cathode for batteries comprises a continuous film 1 of electrically conducting material, e.g., copper or aluminum, which has a substantially planar shape and that is coated at least in part, and on both of its opposite faces, by a coating layer 3, e.g., graphite or other similar material, or in any case suitable for this purpose.

In practice, the film 1 is initially wound as a coil and it is unwound by sliding it during the production process and then wound again at the end of the manufacturing.

During manufacturing, more processes or production stages can be performed, among which the first is usually the deposition of graphite (or other similar material) with the associated drying.

Depending on the applications, for example based on the thickness and/or other factors, the graphite (or other similar material) can be printed, spread or dropped, and more layers of graphite (or of other similar material) can also be deposited.

Another step comprises for example the calendering where the material is pressed by passing between specific rolls.

In all the various processes or production stages an apparatus 100 according to the disclosure can be installed.

Depending on the applications, the coating layer 3 arranged on the faces of the conducting film 1 can be made by an entire sheet, or by separate parts of a proper geometry, e.g., slabs or bands of rectangular shape more or less elongated, patterns, i.e. small quadrangular shaped patches, etc.

Such coating layer is represented in FIG. 1 by only one couple of substantially squared patches 3, represented for the sake of simplicity as arranged only on the upper face of film 1, while the coating layer is represented in FIG. 2 by two couples of substantially squared patches in which one couple of patches 3 is arranged on the upper face of film 1, and the other couple of patches 3 is arranged on the opposite lower face of film 1.

As illustrated in FIG. 1, the apparatus 100 according to the disclosure comprises at least:
an electronic controlling unit or controller 10 (for the sake of simplicity below referred to as controller 10);
at least a first device which is arranged along a path along which the anode or cathode to be controlled is passed and which comprises, arranged at a first face of the film 1, i.e. for example (with respect to film 1) on the upper half-plane as illustrated in

FIG. 1:
a first Contact Image Sensor 12 (CIS);
a first light beam splitter 14;
a first illuminator 16; and
a second illuminator 18.

In particular, the first illuminator 16 is configured to send on the first light beam splitter 14 first light beams A, and the first light beam splitter 14 is configured in order to deflect at least part of the emitted first light beams A towards a first face of the anode or cathode, e.g. the upper face.

As illustrated in the Figures, the deflected light beams impinge on the upper face of the anode or cathode by illuminating it, and they are reflected towards the first contact image sensor 12.

For example, the first illuminator 16 can be a LED illuminator with a diffuser, with parallel beam or with diffused light.

The second illuminator 18 is configured to send second light beams B substantially grazing toward said first face or upper face of the anode or cathode to be controlled.

The definition of grazing light beams is herein to be intended as including light beams which develop a properly chosen acute angle together with a plane of a face of the film 1.

For example, the second illuminator 18 can be of various types: with light at parallel beams, with diffused light or with focused light.

Conveniently, the at least one controller 10 is configured to drive the first illuminator 16 and the second illuminator 18 so that they emit respectively the first and second light beams A, B in a synchronized and alternating manner with each other.

The first contact image sensor 12 is configured to capture first and second images, e.g. interlaced or concatenated between each other, of at least a part of said first face of the anode or cathode when illuminated by said at least part of first deflected light beams A and from said second substantially gazing light beams B, respectively.

Usefully, the at least one controller 10 is configured to detect the presence of one or more defects which may be present on at least said first face of the anode or cathode at least based on said first and second images captured by the first contact image sensor 12.

For example, the first captured images are analyzed by the controller 10 to perform measurements of the anode or cathode which is being controlled, to detect geometric defects, for instance by assessing the correctness of the distance of the edge of the coating 3 on the upper face (or of each one of its components, be it a patch, or a rectangular lamina, etc.) from the edge of the underlying film 1, the mutual alignment between the components forming the coating layer 3 (be them patches, rectangular laminae arranged to form two or more lines, etc.).

For example, the second captured images are analyzed by the controller 10 to detect different types of defects of the anode or cathode that is being controlled, such as the presence of cracks, wrinkles, intrusions of other materials, depressions, smears, etc.

In a particularly preferred embodiment, illustrated in FIG. 2, the apparatus 100 according to the disclosure further comprises a second device which is also arranged along the path along which the anode or cathode to be controlled is passed, and which comprises, arranged at a second face of film 1 opposite to the first face, i.e. for instance (with respect to the film 1) on the half-plane as illustrated in FIG. 2:
a second Contact Image Sensor 22 (CIS);
a second light beam splitter 24;
a third illuminator 26;
a fourth illuminator 28.

In particular, the third illuminator 26 is configured so as to send on the first light beam splitter 14 third light beams C, and the second light beam splitter 24 is configured to deflect at least part of the third light beams C emitted towards a second face of the anode or cathode, e.g., the lower face.

As illustrated in the Figures, such deflected light beams impinge on the lower face of the anode or cathode by illuminating it, and they are reflected towards the second contact image sensor 22.

The fourth illuminator 28 is configured so as to send fourth substantially grazing light beams D towards the second face or lower face of the anode or cathode which is being controlled.

Conveniently, the at least one controller 10 is configured to drive the third illuminator 26 and the fourth illuminator 28 so that they emit the third and fourth light beams C and D in a synchronized and alternating manner with each other, respectively.

The second contact image sensor 22 is configured to capture third and fourth images, e.g., interlaced or concatenated with each other, of at least said second face of the anode or cathode when illuminated by said at least part of third deflected light beams C and said fourth substantially grazing light beams D, respectively.

Usefully, the at least one controller 10 is configured to detect the presence of one or more defects that may be present on at least said second face of the anode or cathode at least based on said third and fourth images captured by the second contact image sensor 22.

For example, the third images are used by the controller 10 to highlight the defects that may be present on the lower face of the anode or cathode which is being controlled, which are similar to the above indicated ones which can be detected by using the first images.

Similarly, the fourth images are used by the controller 10 for example to highlight the defects that may be present on the lower face of the anode or cathode which is being controlled, which are similar to the above indicated ones which can be detected by using the second images.

In a possible embodiment, the second device, as a whole and its components, is substantially identical to the first device and its corresponding components.

Advantageously, in a preferred embodiment of the apparatus 100 according to the disclosure, the at least one controller 10 is configured to detect the presence of at least one defect that may be present in the anode or cathode which is being controlled based on comparing the first and third images captured from the first contact image sensor 12 and from the second contact image sensor 22, respectively.

In particular, the at least one controller 10 is configured to verify if the components forming the coating layer 3 on the upper face of the film 1, being them a single sheet, patches, rectangular laminae etc., are substantially aligned each with a corresponding component (single coating sheet, patches, laminae, etc.) of the components forming the coating layer 3 on the lower face of the film 1.

In a possible embodiment, the at least one controller 10 is configured to drive at least one of said first illuminator 16 and third illuminator 26, preferably both, so that each one emits said first light beams A and respectively third light beams C, for a predetermined time interval comprised between 1 μs and 30 μs, preferably between 10 μs and 20 μs.

Conveniently, each of such time intervals is selectively modifiable in function of the applications so as to balance the need of proper production times with the need of effective detection of the first and third images.

In a possible embodiment, the at least one controller 10 is configured so to drive at least one of said second illuminator 18 and fourth illuminator 28, preferably both, so that each one emits said second light beams B and respectively said fourth light beams D, for a predetermined time interval comprised between 1 μus and 30 μs, preferably between 10 μs and 20 μs.

Conveniently, also each of such time intervals is selectively modifiable in function of the applications so as to balance the need of proper production times with the need of effective detection of the second and fourth images in which the apparatus 100 is used.

In particular, the first and second light beams A and B can be emitted alternatively and in sequence with each other substantially without any temporal break, or it is possible to include a temporal break between the two respective time intervals, which is selectable in function of the operating speed of the plant where the apparatus 100 is used.

In particular, the at least one controller 10 can be configured so as to drive the first and second illuminators 16, 18 in a synchronized and alternating manner with each other independently of the third and fourth illuminators 26, 28 or the at least one controller can be configured to drive simultaneously with each other the first and third illuminators 16, 26 and simultaneously with each other the second and fourth illuminators 18, 28.

In this last case, the controller 10 drives in a synchronized and alternating manner with each other the couples of illuminators 16-26 and 18-28.

In the embodiments illustrated in FIGS. 1 and 2, it is illustrated only one controller 10 associated to both devices.

Clearly, depending on the applications, it is possible to use two controllers 10 associated to a first or second device, respectively.

The or each controller 10 may comprise or be constituted by any device based on a processor, e.g., a microprocessor, a microcontroller, a microcomputer, a programmable logic controller of a commercially available type, properly programmed and provided to the necessary extent with circuits, in order to perform the innovative functionalities designed for the apparatus 100 according to the present disclosure.

The controller 10 can comprise other components, for example a storage unit, and it can be of the concentrated type, i.e. constituted by a single unit, or of the distributed type, i.e. constituted by two or more parts collaboratively associated with each other.

In a possible embodiment, at least one of said first contact image sensor 12 and second contact image sensor 22 is positioned so as to have the respective field of view arranged in a virtual plane substantially perpendicular to an X direction substantially rectilinear along which the anode or cathode to be controlled is passed.

Such a plane, represented as dashed in FIGS. 1 and 2 and therein indicated by the capital letter Y, is, for example, perpendicular to the plane of the sheets on which FIGS. 1 and 2 are represented.

In turn, the substantially rectilinear direction X along which the anode or cathode to be controlled is passed, is a direction which substantially parallel to or lying on the plane of the sheets.

Preferably, either the first contact image sensor 12 or the second contact image sensor 22 are positioned to have the respective field of view arranged on a virtual plane Y which is substantially perpendicular to the direction X along which the anode or cathode to be controlled is passed.

In particular, depending on the applications, the two contact image sensors 12 and 22 can be arranged with the respective field of view arranged in the same plane Y, or they can be shifted with each other, i.e. arranged on two respective virtual planes Y parallel to each other.

In this case, the distance between the two planes can be properly selected when installing the apparatus 100.

In a possible embodiment, at least one of said first light beam splitter 14 and second light beam splitter 24 is configured to deflect towards the anode or cathode which is being controlled, at least a percentage of the first light beams A or of the respective third light beams C emitted by the first illuminator 16 or respectively by the third illuminator 26 between 30% and 70%, preferably between 40% and 60%, more preferably about 50%.

Preferably, both said first light beam splitter 14 and second light beam splitter 24 are configured to deflect towards the anode or cathode which is being controlled, at least a percentage of the first light beams A or of the respective third light beams C emitted from the first illuminator 16 or respectively from the third illuminator 26 between 30% and 70%, preferably between 40% and 60%, more preferably about 50%.

In a possible embodiment, at least one of said first light beam splitter 14 and second light beam splitter 24 comprises an at least partially reflective surface which develops according to an inclined plane forming with the film 1 a respective acute angle α comprised between 30° and 70°, preferably between 40° and 60°, more preferably of about 45°.

Preferably, both said first light beam splitter 14 and second light beam splitter 24 comprise both an at least partially reflective surface which develops according to an inclined plane forming with the film 1 a respective acute angle α comprised between 30° and 70°, preferably between 40° and 60°, more preferably of about 45°.

In a possible embodiment, at least one of said second illuminator 18 and fourth illuminator 28 is configured to send said second light beams B and respectively fourth substantially grazing light beams D towards the anode or cathode to be controlled, inclined with respect to the film 1 by an acute angle β comprised between 5° and 30°, preferably between 8° and 20°, more preferably of about 15°.

Preferably, both said second illuminator 18 and fourth illuminator 28 are configured to send said second light beams B and respectively fourth substantially grazing light beams D towards the anode or cathode to be controlled, inclined with respect to the film 1 by an acute angle β comprised between 5° and 30°, preferably between 8° and 20°, more preferably of about 15°.

In a possible embodiment, e.g., depending on the width of the anode or cathode to be controlled, which can usually range between 300 mm and 1700 mm, the first device can comprise two first contact image sensors 12 (the second of which is not illustrated in the Figures) e.g., identical with each other and arranged at a first face of the film 1, e.g., they are smaller than a first contact image sensor when used alone.

The two first contact image sensors 12 can be arranged next to each other or in any proper reciprocal position with each other, so that the sum of their respective fields of view covers the desired width of the anode or cathode to be controlled, and that both of them will capture respectively first and second images of the portions of the first face of the anode or cathode assigned to each of them when the first face is illuminated by said at least part of the first light beams A deflected and by said second light beams B, respectively.

In particular, in this embodiment it is possible to use a single first light beam splitter 14 properly positioned to deflect at least part of said first light beams A toward said first face of the anode or cathode which are then reflected towards both of the two first contact image sensors 12, or it is possible to use two first light beam splitters 14, each of them associated with a respective first contact image sensor 12.

Similarly, the second device can comprise, arranged at a first face of the film 1, two second contact image sensors 22 (the second of which is not illustrated in the Figures), for example substantially identical with each other, e.g., smaller than a second contact image sensor when used alone.

The two second contact image sensors 22 can be arranged next to each other or in any proper position reciprocal with each other so that the sum of their respective fields of view covers the desired width of the anode or cathode to be controlled, and that both of them will capture respective third and fourth images of the portions of said second face of the anode or cathode assigned to each of them when the second face is illuminated by said at least part of the third light beams C deflected and said fourth light beams D, respectively.

Also in the second device it is possible to use a single second light beam splitter 24 properly positioned to deviate at least part of said third light beams C toward said second face of the anode or cathode which are then reflected towards both the two second contact image sensors 22, or it is possible to use two second light beam splitters 24 each of them associated to a respective second contact image sensor 22.

Clearly, in the attached Figures, the various components of the apparatus are represented in a schematical manner for the sake of illustrative clarity. Their dimensions, the positioning with each other and with respect to the anode or cathode to be controlled, e.g., the distance from the anode and cathode, may be properly varied in function of the applications.

For example, in FIGS. 1 and 2 the first illuminator 16 and the second illuminator 18 are illustrated as positioned on the same side with respect to the first light beam splitter 14, but they may be arranged on opposite sides with respect to it, e.g., as illustrated for the third illuminator 26 and the fourth illuminator 28 with respect to the second light beam splitter 24.

Practically, it has been evidenced that the apparatus 100 according to the disclosure suitably fulfills the intended scope, since it allows to effectively detect defects in the production of anodes and cathodes for batteries.

Moreover, the apparatus 100 has a structure which makes it suitable for being used either in new plants, or in already operating plants for the production of batteries, and/or of anodes and/or cathodes for batteries.

In such plants it is possible to use more apparatuses 100 at a certain distance and functionally separated with each other and distributed along different controlling units of the plant.

Of course, given the principle of the disclosure, the embodiments and their particulars can be widely varied with respect to what has been described and illustrated by way of non-limiting examples only, without stepping outside the scope of protection of the present disclosure, defined by the attached claims, comprising any possible, also partial, combination of the above-described embodiments. For example, the or each contact image sensor may comprise or be constituted by any CIS which is available on the market and suitable for being used in the apparatus 100; the components illustrated in the Figures can be positioned in a different way with respect to what has been shown, as long as it is compatible with the scope for which they are intended to be used in the frame of the disclosure, etc.

1. Apparatus for detecting defects in an anode or cathode for batteries, said anode or cathode comprising a film of electrically conducting material coated at least in part, and on both of its opposite faces, by a coating layer, wherein the apparatus comprises:
at least one controller;
at least a first device which is arranged along a path along which said anode or cathode to be controlled is passed and which comprises, arranged at a first face of the film:
a first contact image sensor;
a first light beam splitter;
a first illuminator which is configured to send on said first light beam splitter first light beams, said first light beam splitter being configured to deflect at least part of said first light beams towards said first face of the anode or cathode;
a second illuminator configured to send second beams of substantially grazing light toward said first face of the anode or cathode;
wherein said at least one controller is configured to drive said first and second illuminators so that they emit said first and second light beams in a synchronized and alternating manner with each other;
wherein said at least one controller is configured to drive said first and second illuminators so that they emit said first and second light beams in a synchronized and alternating manner with each other;
wherein said first contact image sensor is configured to capture first and second images of at least part of said first face of the anode or cathode when illuminated by said at least part of said first light beams deflected and said second light beams, respectively;
and wherein said at least one controller is configured to detect the presence of one or more defects that may be present on at least said first face of said anode or cathode at least based on said first and second images captured by said first contact image sensor.

2. Apparatus according to claim 1, further comprising at least a second device which is arranged along a path along which said anode or cathode to be controlled is passed and which comprises, arranged at a second face of the film opposite to the first face:
a second contact image sensor;
a second light beam splitter;
a third illuminator which is configured to send on said second light beam splitter third light beams, said second light beam splitter being configured to deflect at least part of said third light beams towards said second face of the anode or cathode;
a fourth illuminator configured to send fourth beams of substantially grazing light toward said second face of the anode or cathode;
wherein said at least one controller is configured to drive said third and fourth illuminators so that they emit said third and fourth light beams in a synchronized and alternating manner with each other;
wherein said at least one controller is configured to drive said third and fourth illuminators so that they emit said third and fourth light beams in a synchronized and alternating manner with each other;
wherein said second contact image sensor is configured to capture third and fourth images of at least part of said second face of the anode or cathode when illuminated by said at least part of said third light beams deflected and said fourth light beams, respectively;
and wherein said at least one controller is configured to detect the presence of one or more defects that may be present on at least said second face of said anode or cathode at least based on said third and fourth images captured by said second contact image sensor.

3. Apparatus according to claim 2, wherein said at least one controller is configured to detect the presence of at least one defect that may be present in said anode or cathode based on comparing said first and third images captured by said first contact image sensor and said second contact image sensor, respectively.

4. Apparatus according to claim 1, wherein the first contact image sensor is positioned to have its field of view arranged in a virtual plane substantially perpendicular to a direction substantially rectilinear along which said anode or cathode to be controlled is passed.

5. Apparatus according to claim 2, wherein the second contact image sensor is positioned to have its field of view arranged in a virtual plane substantially perpendicular to a direction substantially rectilinear along which said anode or cathode to be controlled is passed.

6. Apparatus according to claim 1, wherein the first light beam splitter is configured to deflect toward said anode or cathode at least a percentage of the first light beams emitted by the first illuminator comprised between 30% and 70%.

7. Apparatus according to claim 2, wherein the second light beam splitter is configured to deflect toward said anode or cathode at least a percentage of the third light beams emitted by the third illuminator comprised between 30% and 70%.

8. Apparatus according to claim 1, wherein the first light beam splitter comprises an at least partially reflective surface which develops according to an inclined plane forming with said film an acute angle comprised between 30° and 70°.

9. Apparatus according to claim 2, wherein the second light beam splitter comprises an at least partially reflective surface which develops according to an inclined plane forming with said film an acute angle comprised between 30° and 70°.

10. Apparatus according to claim 1, wherein the second illuminator is configured to send said second beams toward said anode or cathode, inclined with respect to the film by an acute angle comprised between 5° and 30°.

11. Apparatus according to claim 2, wherein the fourth illuminator is configured to send said fourth beams of substantially grazing light toward said anode or cathode inclined with respect to the film by an acute angle comprised between 5° and 30°.

12. Apparatus according to claim 1, wherein said at least one controller is configured to drive said first illuminator to emit said first light beams for a time interval comprised between 1 μus and 30 μs.

13. Apparatus according to claim 2, wherein said at least one controller is configured to drive said third illuminator to emit said third light beams for a time interval comprised between 1 μs and 30 μs.

14. Apparatus according to claim 1, wherein said at least one controller is configured to drive said second illuminator to emit said second light beams for a time interval comprised between 1 μs and 30 μs.

15. Apparatus according to claim 2, wherein said at least one controller is configured to drive said fourth illuminator to emit said fourth light beams for a time interval comprised between 1 μs and 30 μs.

16. Apparatus according to claim 1, wherein said first device further comprises at least one additional first contact image sensor configured to capture respective first and second images of at least part of said first face of the anode or cathode when illuminated by said at least part of said first light beams deflected and said second light beams, respectively.

17. Apparatus according to claim 2, wherein said second device further comprises at least one additional second contact image sensor configured to capture respective third and fourth images of at least part of said second face of the anode or cathode when illuminated by said at least part of said third light beams deflected and said fourth light beams, respectively.

18. Plant for producing batteries, and/or anodes and/or cathodes for batteries, comprising at least one apparatus according to claim 1.
